(19) United States
(12) Patent Application Publication
(10) Pub. No.: US 2025/0244928 A1
(43) Pub. Date: Jul. 31, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventor: Masayoshi ARIJI, Kanagawa (JP)

(73) Assignee: FUJIFILM Business Innovation Corp., Tokyo (JP)

(21) Appl. No.: 18/761,345

(22) Filed: Jul. 2, 2024

(30) Foreign Application Priority Data
Jan. 29, 2024 (JP) 2024-011165

(51) Int. Cl. G06F 3/12

(52) U.S. Cl. CPC G06F 3/1239; G06F 3/1219

(57) ABSTRACT

An information processing system includes: a processor configured to: in a case where the information processing system is not connected to the Internet, perform control to prohibit use of the information processing system in a case where a program for controlling an operation of the information processing system is not updated by a set deadline.

### CROSS-REFERENCE TO RELATED APPLICATIONS

This application is based on and claims priority under 35 USC 119 from Japanese Patent Application No. 2024-011165 filed Jan. 29, 2024.

### BACKGROUND

### (i) Technical Field

The present disclosure relates to an information processing system, a non-transitory computer readable medium storing a program, and an information processing method.

### (ii) Related Art

JP2006-235791A describes an image processing apparatus that downloads and operates a file on which processing of individually embedding a serial ID number of a device in a firmware file to be downloaded has been performed, to allow only a registered user and a designated user to operate the file.

### SUMMARY

There is an intention to prohibit use of an information processing system that has been unaccounted for or an information processing system that has been occupied in a manner not intended by an owner, or the like, but in a case where these information processing systems are not connected to the Internet, the use by a remote operation cannot be prohibited.

Aspects of non-limiting embodiments of the present disclosure relate to an information processing system, a non-transitory computer readable medium storing a program, and an information processing method that can prohibit use even in a case where the information processing system is not connected to the Internet.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including: a processor configured to: in a case where the information processing system is not connected to the Internet, perform control to prohibit use of the information processing system in a case where a program for controlling an operation of the information processing system is not updated by a set deadline.

### BRIEF DESCRIPTION OF THE DRAWINGS

Exemplary embodiment(s) of the present invention will be described in detail based on the following figures, wherein:

FIG. 1 is a diagram showing a system configuration of an image forming system of an exemplary embodiment of the present disclosure;

FIG. 2 is a block diagram showing a hardware configuration of an image forming apparatus of the exemplary embodiment of the present disclosure;

FIG. 3 is a block diagram showing a functional configuration of the image forming apparatus of the exemplary embodiment of the present disclosure;

FIG. 4 is a diagram showing an example of a consumable of the image forming apparatus of the exemplary embodiment of the present disclosure;

FIG. 5 is a diagram showing an example of a configuration of firmware;

FIG. 6 is a flowchart illustrating a flow of processing during operation determination in the image forming apparatus; and

FIG. 7 is a flowchart illustrating a flow of processing during firmware program update in the image forming apparatus.

### DETAILED DESCRIPTION

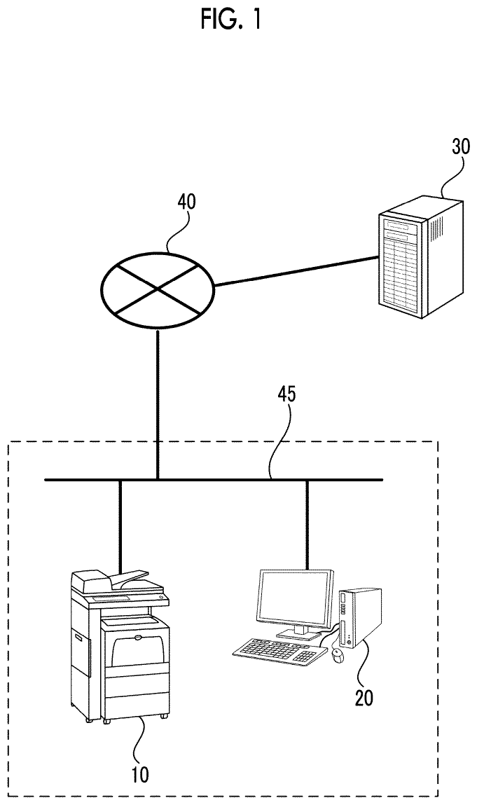

Hereinafter, an exemplary embodiment for implementing the technology of the present disclosure will be described in detail with reference to the drawings. FIG. 1 is a diagram showing a system configuration of an image forming system of an exemplary embodiment.

As shown in FIG. 1, the image forming system of the present exemplary embodiment is composed of an image forming apparatus 10, a user terminal 20, and a management server 30.

The image forming apparatus 10 is a so-called multifunction apparatus having a plurality of functions such as a printing function, a scanning function, a copying function, and a facsimile function. The image forming apparatus 10 is an example of an information processing system in the technology of the present disclosure.

The user terminal 20 is connected to the image forming apparatus 10 via a local network 45 and is a terminal for using the functions of the image forming apparatus 10.

The management server 30 is a server for controlling an operation of the image forming apparatus 10 or supplying a firmware program for controlling the operation of the image forming apparatus 10. The firmware program is an example of a program for controlling the operation of the image forming apparatus 10. The management server 30 is connected to the local network 45 via the Internet 40.

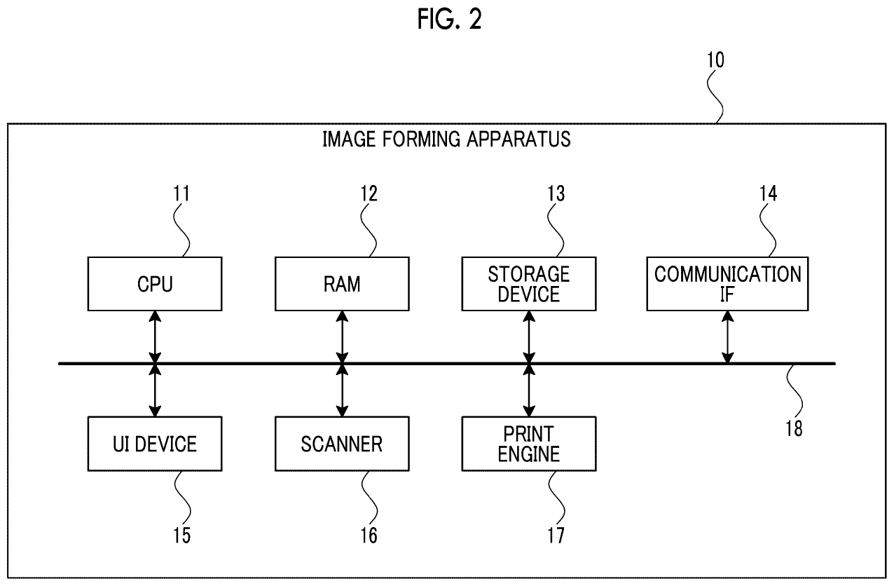

Next, a hardware configuration of the image forming apparatus 10 in a data processing system of the present exemplary embodiment is shown in FIG. 2.

As shown in FIG. 2, the image forming apparatus 10 includes a central processing unit (CPU) 11, a random access memory (RAM) 12, a storage device 13 such as a hard disk drive, a communication interface (abbreviated as IF) 14, a user interface (abbreviated as UI) device 15 including a touch panel or a liquid crystal display, and a keyboard, a scanner 16, and a print engine 17. These components are connected to each other via a control bus 18.

The communication IF 14 performs transmission and reception of data with respect to an external device or the like via the Internet 40. The UI device 15 accepts an instruction input from a user. The scanner 16 scans a document loaded in the image forming apparatus 10 as image data. The print engine 17 prints an image on a recording medium such as printing paper through processes such as charging, exposure, development, transfer, and fixing.

The CPU 11 is a processor that executes predetermined processing based on a firmware program stored in the RAM 12 or the storage device 13 to control the operation of the image forming apparatus 10. It should be noted that, in the present exemplary embodiment, the CPU 11 has been described as reading and executing the firmware program stored in the RAM 12 or the storage device 13, but the present disclosure is not limited thereto. The firmware program may be provided in a form of being recorded on a computer readable recording medium. For example, the program may be provided in a form of being recorded on an optical disk such as a compact disc (CD)-read only memory (ROM) and a digital versatile disc (DVD)-ROM, or in a form of being recorded on a semiconductor memory such as a universal serial bus (USB) memory and a memory card. In addition, the firmware program may be acquired from an external device via a communication line connected to the communication interface 14.

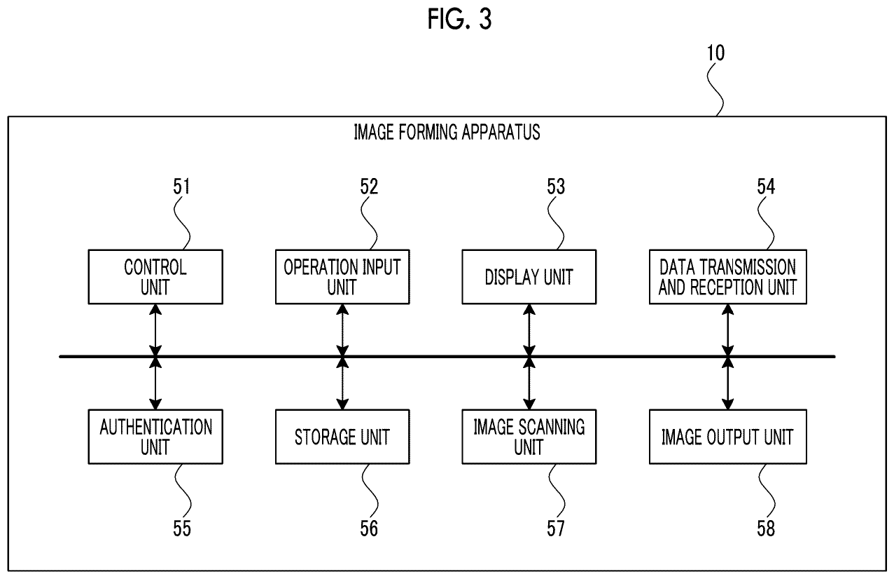

FIG. 3 is a block diagram showing a functional configuration of the image forming apparatus 10 implemented by executing the above-described firmware program.

As shown in FIG. 3, the image forming apparatus 10 of the present exemplary embodiment includes a control unit 51, an operation input unit 52, a display unit 53, a data transmission and reception unit 54, an authentication unit 55, a storage unit 56, an image scanning unit 57, and an image output unit 58.

The control unit 51 controls an overall operation of the image forming apparatus 10 and performs control to scan a document image through the image scanning unit 57, control to output print data from the image output unit 58, and the like, based on the instruction input from the user.

The operation input unit 52 inputs information on various operations performed by the user. The display unit 53 is controlled by the control unit 51 and displays various types of information to the user. The data transmission and reception unit 54 performs transmission and reception of data with respect to an external device such as the user terminal 20. The authentication unit 55 executes an authentication process for a user who attempts to use the image forming apparatus 10.

The storage unit 56 stores data such as firmware. The image scanning unit 57 scans the document image from the loaded document based on the control by the control unit 51. The image output unit 58 outputs an image on a recording medium such as printing paper based on the control by the control unit 51.

An administrator of the image forming apparatus 10 may have a need to prohibit the use of the image forming apparatus 10 that has been unaccounted for, the image forming apparatus 10 that has been occupied in a manner not intended by the administrator, or the like. In a case where the image forming apparatus 10 for which the operation is to be prohibited is connected to the Internet 40, the use of the image forming apparatus 10 can be prohibited by the management server 30 through the remote operation, but in a case where the image forming apparatus 10 for which the operation is to be prohibited is not connected to the Internet 40, the use of the image forming apparatus 10 cannot be prohibited by the management server 30 through the remote operation.

In order to address such an issue, the control unit 51 of the image forming apparatus 10 of the present exemplary embodiment performs, in a case where the image forming apparatus 10 is not connected to the Internet 40, control to prohibit the use of the image forming apparatus 10 in a case where the firmware program for controlling the operation of the image forming apparatus 10 is not updated by a set deadline.

The firmware program can be upgraded, for example, at regular intervals such as every month or every six months. The image forming apparatus 10 that is licitly used is typically connected to the management server 30 via the Internet 40, and in a case where the firmware program has been updated, a new firmware program is downloaded from the management server 30 and the firmware program is updated to the latest firmware program.

However, the firmware program of the image forming apparatus 10 that is illicitly used without being connected to the Internet 40 may not be regularly updated. Therefore, by prohibiting the use of the image forming apparatus 10 in which the firmware program has not been updated by the set deadline, the illicit use of the image forming apparatus 10 can be prevented.

Here, the “set deadline” may be set to any deadline as long as the set deadline is a deadline sufficient to presume the illicit use of the image forming apparatus 10.

For example, in a case where the firmware program is regularly updated, a date after a period that allows a certain margin for the regular update period, based on the previous update date of the firmware program, may be set as the deadline. Specifically, in a case where the firmware program is regularly updated every month, the date two months after the previous update date of the firmware program may be set as the deadline.

In addition, regardless of the presence or absence of the regular update of the firmware program, in a case where the update of the firmware program is expected at least once in a predetermined period, a date after a period that allows a certain margin for the predetermined period, based on the previous update date of the firmware program, may be set as the deadline. Specifically, in a case where the update of the firmware program is expected at least once in half a year, the date eight months after the previous update date of the firmware program may be set as the deadline.

Further, “the control to prohibit the use of the image forming apparatus 10” may be any content as long as the control is control to put the image forming apparatus 10 into a state in which the image forming apparatus 10 cannot be used by the user, and for example, “the control to prohibit the use of the image forming apparatus 10” may be control to prohibit the startup of the image forming apparatus 10 or may be control to not accept the operation by the user even in a case where the image forming apparatus 10 has been started.

In the present exemplary embodiment, the control unit 51 may perform, in a case where the firmware program for operating the image forming apparatus 10 has not been updated for a set period, control to prohibit the use of the image forming apparatus 10 in a case where a manufacturing date of a mounted consumable satisfies a set condition.

The consumable mounted in the image forming apparatus 10 is, for example, a drum cartridge, a toner cartridge, or the like used in the print engine 17.

Here, the condition is that, for example, the manufacturing date (for example, the lot) of the consumable may be later than the provision date of the firmware program, or the manufacturing date (for example, the lot) of the consumable may be later than the shipping date of the image forming apparatus 10.

In addition, the control unit 51 may perform, in a case where the firmware program has been updated, control to prohibit the use of the image forming apparatus 10 in a case where an individual identification number of an image forming apparatus for which the operation included in the firmware program is prohibited matches an individual identification number of the image forming apparatus 10.

In this case, the control unit 51 may update, in a case where the image forming apparatus 10 has been connected to the Internet 40, the firmware program through the connection to the management server 30.

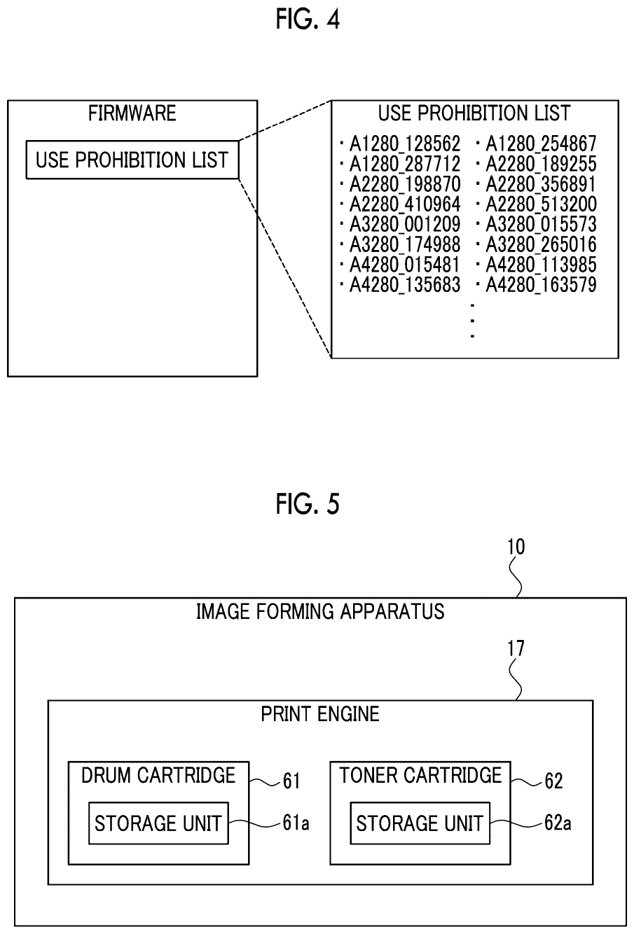

Specifically, as shown in FIG. 4, the administrator can list the individual identification numbers of the image forming apparatuses suspected of the illicit use as a use prohibition list and include the list in the firmware program.

In a case where the firmware program has been updated, the control unit 51 prohibits the use of the image forming apparatus 10 in a case where the individual identification number included in the use prohibition list included in the firmware program matches the individual identification number of the image forming apparatus 10.

In addition, in a case of prohibiting the use of the image forming apparatus 10, the control unit 51 may also disable the use of the consumable mounted in the image forming apparatus 10 in the image forming apparatus 10 and an apparatus other than the image forming apparatus 10.

In this case, in order to disable the use of the consumable, the control unit 51 need only set the identifier that is stored in a storage unit provided in the consumable and that indicates that the use is prohibited, to be prohibited.

Specifically, as shown in FIG. 5, in the print engine 17 of the image forming apparatus 10, a drum cartridge 61 and a toner cartridge 62 are used as consumables. The drum cartridge 61 includes a storage unit 61a in which an identifier indicating that the use is prohibited is stored. Similarly, the toner cartridge 62 includes a storage unit 62a in which an identifier indicating that the use is prohibited is stored.

In a case where the identifier is set in a state indicating that the use is prohibited, in a similar apparatus including the image forming apparatus 10, the use of the drum cartridge 61 and the toner cartridge 62 can be disabled.

In a case of prohibiting the use of the image forming apparatus 10, the control unit 51 need only set the identifier stored in the storage unit 61a of the drum cartridge 61 and the identifier stored in the storage unit 62a of the toner cartridge 62 to a state indicating that the use is prohibited.

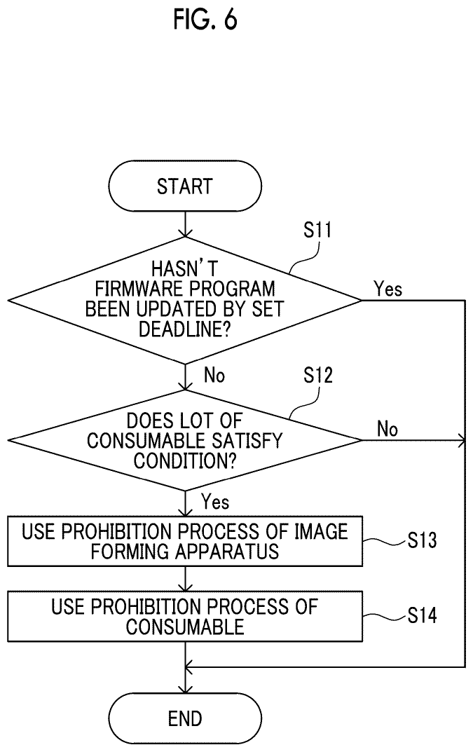

Next, a flow of processing during operation determination in the image forming apparatus 10 of the present exemplary embodiment will be described with reference to the flowchart of FIG. 6.

In step S11, the control unit 51 determines whether or not the firmware program has been updated by the set deadline.

In step S11, in a case where determination is made that the firmware program has been updated by the set deadline, that is, in a case where determination is made that the determination result is “Yes”, the control unit 51 ends an operation determination process.

In step S11, in a case where determination is made that the firmware program has not been updated by the set deadline, that is, in a case where determination is made that the determination result is “No”, the control unit 51 determines whether or not the lot of the consumable satisfies the condition in step S12. Here, as an example, determination is made whether or not the lot of the consumable is later than the provision date of the firmware program.

In step S12, in a case where determination is made that the lot of the consumable is not later than the provision date of the firmware program, that is, in a case where determination is made that the determination result is “No”, the control unit 51 ends the operation determination process.

In step S12, in a case where determination is made that the lot of the consumable is later than the provision date of the firmware program, that is, in a case where determination is made that the determination result is “Yes”, the control unit 51 performs a use prohibition process of the image forming apparatus 10 in step S13, then performs the use prohibition process of the consumable in step S14, and ends the operation determination process.

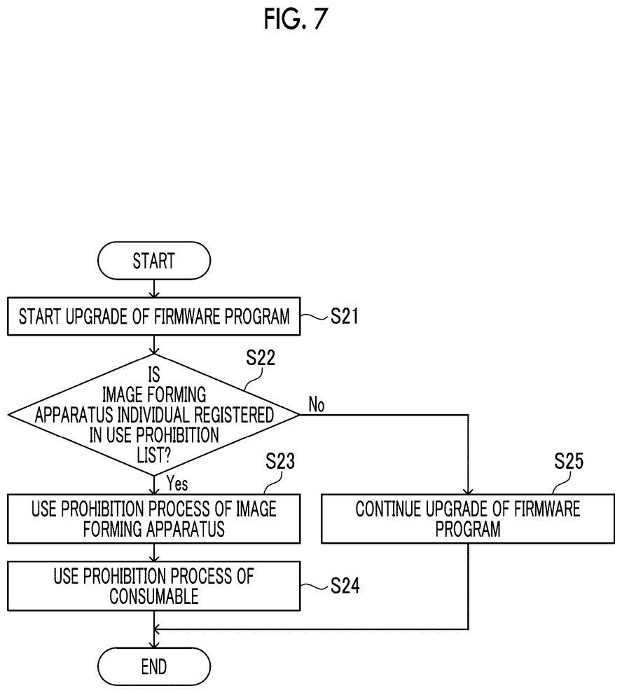

Next, a flow of processing in a case of upgrading the firmware program in the image forming apparatus 10 of the present exemplary embodiment will be described with reference to the flowchart of FIG. 7.

In step S21, the control unit 51 starts the upgrade of the firmware program.

Next, in step S22, the control unit 51 determines whether or not the image forming apparatus 10 is an individual registered in the use prohibition list included in the firmware program.

In step S22, in a case where determination is made that the image forming apparatus 10 is the individual registered in the use prohibition list, that is, in a case where determination is made that the determination result is “Yes”, the control unit 51 stops an upgrade process of the firmware program, performs the use prohibition process of the image forming apparatus 10 in step S23, then performs the use prohibition process of the consumable in step S24, and ends the upgrade process of the firmware program.

In step S22, in a case where determination is made that the image forming apparatus 10 is not the individual registered in the use prohibition list, that is, in a case where determination is made that the determination result is “No”, the control unit 51 continues the upgrade process of the firmware program in step S25 and ends the processing after the upgrade process of the firmware program is completed.

### Modification Example

Although the image forming system of the exemplary embodiment of the present disclosure has been described above, the technology of the present disclosure is not limited to the above-described exemplary embodiment and can also be appropriately changed.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

In addition, in the exemplary embodiment above, a case where the present disclosure is applied to the image forming apparatus has been described, but the present disclosure is not limited thereto and can also be applied to, for example, various information processing systems such as a scanner.

### SUPPLEMENTARY NOTE

With regard to the exemplary embodiment described above, the following supplementary notes are further disclosed.

(((1))

An information processing system comprising:
a processor configured to:
   in a case where the information processing system is not connected to the Internet, perform control to prohibit use of the information processing system in a case where a program for controlling an operation of the information processing system is not updated by a set deadline.
      (((2)))

The information processing system according to (((1))), wherein the processor is configured to:
in a case where a program for operating the information processing system has not been updated for a set period, prohibit the use of the information processing system in a case where a manufacturing date of a mounted consumable satisfies a set condition.
   (((3)))

The information processing system according to (((2))),
wherein the condition is that the manufacturing date of the consumable is later than a provision date of the program.
   (((4)))

The information processing system according to (((2))),
wherein the condition is that the manufacturing date of the consumable is later than a shipping date of the information processing system.
   (((5)))

The information processing system according to any one of (((1))) to (((4))), wherein the processor is configured to:
in a case where the program has been updated, prohibit the use of the information processing system in a case where an individual identification number of a system for which an operation included in the program is prohibited matches an individual identification number of the information processing system.
   (((6)))

The information processing system according to (((5))), wherein the processor is configured to:
in a case where the information processing system has been connected to the Internet, update the program through connection to a management server.
   (((7)))

The information processing system according to any one of (((1))) to (((6))), wherein the processor is configured to:
in a case of prohibiting the use of the information processing system, also disable the use of a consumable mounted in the information processing system in the information processing system and a system other than the information processing system.
   (((8)))

The information processing system according to (((7))), wherein the processor is configured to:
set an identifier that is stored in a storage unit provided in the consumable and that indicates that the use is prohibited, to be prohibited, to disable the use of the consumable.
   (((9)))

A program for causing a computer to execute:
in a case where an information processing system is not connected to the Internet, performing control to prohibit use of the information processing system in a case where a program for controlling an operation of the information processing system is not updated by a set deadline.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor configured to:
in a case where the information processing system is not connected to the Internet, perform control to prohibit use of the information processing system in a case where a program for controlling an operation of the information processing system is not updated by a set deadline.

2. The information processing system according to claim 1, wherein the processor is configured to:
in a case where a program for operating the information processing system has not been updated for a set period, prohibit the use of the information processing system in a case where a manufacturing date of a mounted consumable satisfies a set condition.

3. The information processing system according to claim 2,
wherein the condition is that the manufacturing date of the consumable is later than a provision date of the program.

4. The information processing system according to claim 2,
wherein the condition is that the manufacturing date of the consumable is later than a shipping date of the information processing system.

5. The information processing system according to claim 1, wherein the processor is configured to:
in a case where the program has been updated, prohibit the use of the information processing system in a case where an individual identification number of a system for which an operation included in the program is prohibited matches an individual identification number of the information processing system.

6. The information processing system according to claim 5, wherein the processor is configured to:
in a case where the information processing system has been connected to the Internet, update the program through connection to a management server.

7. The information processing system according to claim 1, wherein the processor is configured to:
in a case of prohibiting the use of the information processing system, also disable the use of a consumable mounted in the information processing system in the information processing system and a system other than the information processing system.

8. The information processing system according to claim 7, wherein the processor is configured to:
set an identifier that is stored in a storage unit provided in the consumable and that indicates that the use is prohibited, to be prohibited, to disable the use of the consumable.

9. A non-transitory computer readable medium storing a program for causing a computer to execute:
in a case where an information processing system is not connected to the Internet, performing control to prohibit use of the information processing system in a case where a program for controlling an operation of the information processing system is not updated by a set deadline.

10. An information processing method comprising:
in a case where an information processing system is not connected to the Internet, performing control to prohibit use of the information processing system in a case where a program for controlling an operation of the information processing system is not updated by a set deadline.
